(19) United States
(12) Patent Application Publication
(10) Pub. No.: US 2004/0118453 A1
(43) Pub. Date: Jun. 24, 2004

(54) Automatic lock shutoff valve for water systems

(76) Inventor: George Staranchuk, Regina (CA)

Correspondence Address: KIRBY EADES GALE BAKER, BOX 3432, STATION D, OTTAWA, ON, K1P 6N9, CA

(21) Appl. No.: 10/322,444

(22) Filed: Dec. 19, 2002

(51) Int. Cl. F16K 31/11

(52) U.S. Cl. 137/312

(57) ABSTRACT

An automatic leak shut off valve for water systems includes a valve body having a water inlet and a water outlet. Within the valve body is a water flow passage flow connected to the inlet and outlet, this flow passage having a cylindrical recess with a closed bottom wall. A tubular member having a diameter less than that of the cylindrical recess extends into the recess with the bottom edge of the tubular member spaced from the closed bottom wall of the of the recess. A wall member is also provided adjacent the water inlet for directing all water flow from the water inlet into the cylindrical recess. A flexible valve flap is fixed between sidewalls of the cylindrical recess and directly beneath the bottom edge of the tubular member, this flap being biased in a closed position against the tubular member bottom edge by means of a spring mounted between the flap and the bottom wall of the cylindrical recess.

### BACKGROUND OF THE INVENTION

This invention relates to a safety valve for turning off the water in a water supply system, when a leak has been detected.

It can be a very serious problem when a leak develops in a water supply system, such as a home owner's hot water heater. After returning from a vacation or other extended trip, it is not uncommon to find a basement flooded because of a leak which developed in the hot water heater. This can result in extensive and very costly property damage for the home owner.

Various systems have been proposed in the past to prevent damage from such leaks. One such system is described in Frisby, U.S. Pat. No. 4,252,088 issued Feb. 24, 1981. That system uses an arrangement of flappers in the inlet and outlet lines to a domestic hot water heater with a permanent magnet affixed to the bottom portion of each of the flappers. These are used in combination with magnetically operated switches which are in turn connected to a circuit with a relay for controlling a solenoid valve for cutting off or preventing entry of water from a source into an inlet pipe.

Another leakage protection device is described in Moody U.S. Pat. No. 4,805,662 issued Feb. 21, 1989. That system uses a ground fault interrupter circuit for detecting a leak and being adapted to close a solenoid valve thereby terminating the supply of water to the hot water heater when a leakage is detected.

Staranchuk, U.S. Pat. No. 5,694,970, issued Dec. 9, 1997 was an attempt to develop a simpler and less expensive safety valve. In this design a valve flap was spring biased via an actuating pin in the open position and when a leak was detected a solenoid was activated moving the actuating pin and closing the valve flap. When the actuating pin was moved to the closed position, it was engaged by a spring biased locking pin capable only of manual reset.

It is an object of the present invention to provide a still simpler and less expensive design of leakage control valve for a water supply system.

### SUMMARY OF THE INVENTION

The present invention in its broadest aspect relates to a fluid supply shut off valve, in particular an automatic leak shut off valve for a water system. It includes a valve body having a water inlet and a water outlet. Within the valve body is a water flow passage flow connected to the inlet and outlet, this flow passage having a cylindrical recess with a closed bottom wall. A tubular member having a diameter less than that of the cylindrical recess extends into the recess with the bottom edge of the tubular member spaced from the closed bottom wall of the of the recess. A wall member is also provided adjacent the water inlet for directing all water flow from the water inlet into the cylindrical recess. A flexible valve flap is fixed between sidewalls of the cylindrical recess and directly beneath the bottom edge of the tubular member, this flap being biased in a closed position against the tubular member bottom edge by means of a spring mounted between the flap and the bottom wall of the cylindrical recess.

An actuator pin extends axially through the tubular member with one end engaging a face of the valve flap opposite the spring and the other end extending out of the valve body. This actuator pin is adapted to move axially to push the flexible flap away from the tubular member bottom edge and against the spring to thereby permit flow of water between the inlet and outlet. A spring biased and solenoid actuated release pin is mounted in the valve body perpendicular to the actuator pin, with this release pin being adapted to engage a slot in the actuator pin at a location where the valve flap is being held in the open position. The solenoid is adapted to pull the release pin and thereby close the valve upon receiving a signal.

A valve reset lever is preferably mounted externally on the valve body and is adapted to push the actuator pin downwardly into a valve open position where the release pin engages the actuator pin slot and locks the valve in the open position. The water inlet and water outlet are also preferably axially aligned, with the cylindrical recess extending below the inlet and outlet and the tubular member extending into the recess.

The valve flap is conveniently held in place by being clamped between a main valve body and a bottom closure plate. This closure plate preferably includes a cylindrical recess forming part of the valve body cylindrical recess. The flap is preferably formed of an elastomeric sheet material, e.g. a natural or synthetic rubber sheet.

### BRIEF DESCRIPTION OF THE DRAWINGS

In the drawings which illustrate preferred embodiments of the present invention:

FIG. 1 is an elevation in section of a valve of the invention in open position;

FIG. 2 is an elevation in section of the valve of FIG. 1 in closed position;

FIG. 3 is an exploded view of the valve of the invention;

FIG. 4 is a further perspective view of the valve body; and

FIG. 5 is a sectional view along line 5-5.

### DESCRIPTION OF THE PREFERRED EMBODIMENTS

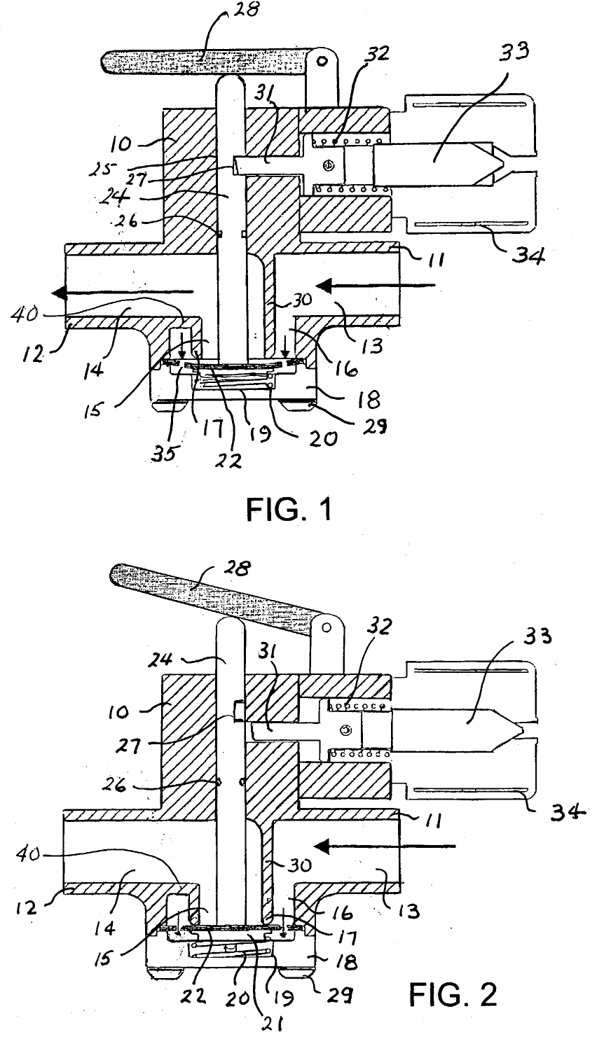

FIGS. 1 and 2 show the valve assembly of the invention in open and closed positions respectively. The unit comprises a main valve body 10 with a water flow inlet connector 11 and an outlet connector 12. The interior of the body includes a cavity 15 flow connected to inlet channel 13 and outlet channel 14. Extending down below the flow channels is a cylindrical recess 16 and within this recess is the downwardly projecting tubular portion 17 of smaller diameter than the recess 16. On the inlet side, the tubular portion 17 extends upwardly into a barrier wall 30 adjacent to inlet channel 13 which directs all water flow down into recess 16 below the lower end of the tubular projection 17.

Fixed in position immediately below the lower edge of tubular projection 17 is a valve flap 22 formed of elastomeric sheet material. This flap 22 is spring biased in an upper direction by means of spring 20 and spring support 21 mounted in the cavity below the flap valve 22. As shown, the flap valve 22 is held firmly in place by being clamped between the main body of the valve 10 and the bottom plate 18 which is held in place by studs 29.

Also extending down through the valve body in a hole 25 is an actuator pin 24, the bottom end of which engages the flap valve 22 and the top end of which extends out of the valve body. The actuator pin 24 includes a slot 27 and at least one sealing O-ring 26. Actuator arm 28 is used to push the actuator pin 24 in a downward direction against the resistance of spring 20 to force the valve flap 22 in the open position as shown in FIG. 1.

The assembly also includes the solenoid unit 34 with a solenoid pin 33 having the release pin extension 31 adapted to engage the slot 27 in actuator pin 24. This release pin 31 is spring biased to engage with the slot 27 by means of spring 32.

The normal operating position for the valve is as shown in FIG. 1 with the water flowing in through inlet channel 13, down around the bottom edge of the tubular projection 17 and out through outlet channel 14. When the solenoid 34 receives a warning signal to shut down the system, the solenoid is activated pulling the pin 33 and release pin 31 into the position shown in FIG. 2. Flap valve 22 immediately snaps to the close position under the pressure of spring 20 and remains in that closed position until the valve is manually reset by pushing down on arm 28 to return the system to the open position as shown in FIG. 1.

Small holes 35 are provided near the periphery of the valve flap 22 so that as can be seen in FIG. 2, these served to equalize water pressure so that a firm water seal is achieved by means of the flexible closure flap 22 and spring 20.

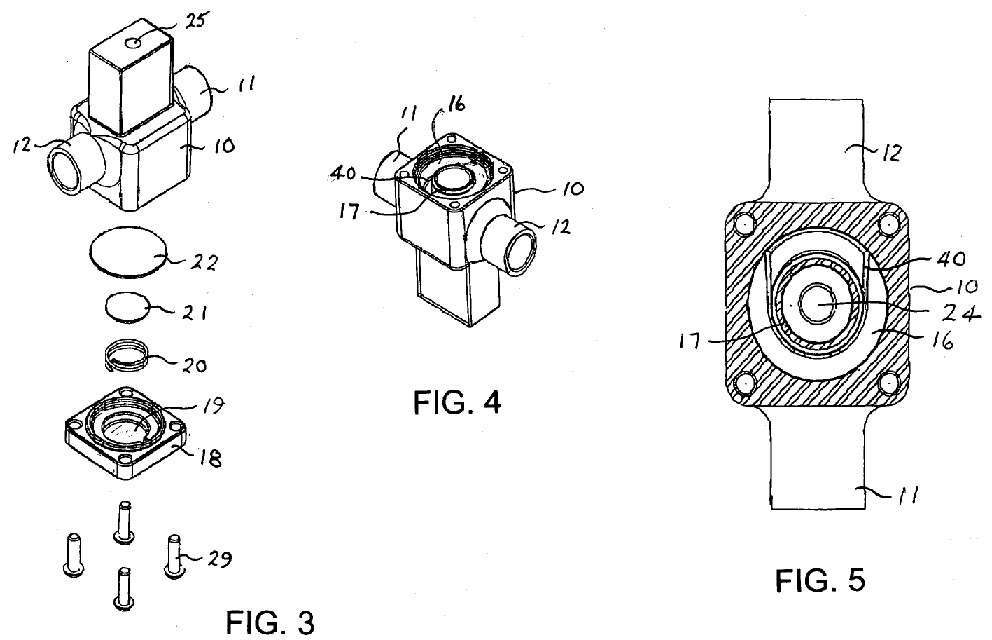

Further details of the individual components of the above assembly can be seen in FIGS. 3, 4 and 5.

1. A fluid supply shut off valve comprising:
(a) a valve body having a water inlet and a water outlet,
(b) a water flow passage within the valve body adapted to flow connect said inlet and outlet, said flow passage including a cylindrical recess with a closed bottom wall, a tubular member of smaller diameter than said recess extending into the recess, said tubular member having a bottom edge spaced from said recess bottom edge and a wall member adapted to direct all water flow from the water inlet to the bottom of the cylindrical recess,
(c) a flexible valve flap fixed between sidewalls of said cylindrical recess, said flap being biased in a closed position against said tubular member bottom edge by means of a spring mounted between the flap and the bottom wall of the cylindrical recess,
(d) an actuator pin extending axially through the tubular member with one end engaging a face of the valve flap opposite said spring and the other end extending out of the valve body, said actuator pin being adapted to move axially to push the flexible flap away from the tubular member bottom edge and against said spring to thereby permit flow of water between the inlet and outlet, and
(e) a spring biased and solenoid actuated release pin mounted in said valve body perpendicular to said actuator pin, said release pin being adapted to engage a slot in the actuator pin at a location where the valve flap is being held in open position, and said solenoid being adapted to pull the release pin and thereby close the valve upon receiving a signal.

2. A shut off valve system according to claim 1, wherein the water inlet and water outlet are axially aligned, with said cylindrical recess extending below the inlet and outlet and said tubular member extending into said recess.

3. A shut off valve system according to claim 2, wherein a valve reset lever arm is mounted externally on the valve body and is adapted to push the actuator pin downwardly into a valve open position where the release pin engages the actuator pin slot.

4. A shut off valve system according to claim 1, wherein the valve flap is clamped between a main valve body and a bottom closure plate.

5. A shut off valve system according to claim 4, the valve flap is formed of an elastomeric material.

6. A shut off valve system according to claim 5, wherein the valve flap has small holes adjacent the periphery and extending into an annular region between the tubular member and the periphery of the cylindrical recess to balance water pressure when the valve flap is closed.

7. A shut off valve system according to claim 4, wherein the bottom closure plate includes a cylindrical recess forming part of the valve body cylindrical recess.
